(19) United States
(12) Patent Application Publication
(10) Pub. No.: US 2023/0001383 A1
(43) Pub. Date: Jan. 5, 2023

(54) Silica-Alumina Composite Materials for Hydroprocessing Applications

(71) Applicant: CHEVRON U.S.A. INC., San Ramon, CA (US)

(72) Inventors: Ann LIANG, Walnut Creek, CA (US); Trenton J. OTTO, El Sobrante, CA (US); Jifei JIA, Hercules, CA (US); Ling JIAO, Richmond, CA (US); Bao Q. LE, Pittsburg, CA (US); Kaustav CHAUDHURI, Vacaville, CA (US); Bi-Zeng ZHAN, Albany, CA (US)

(21) Appl. No.: 17/774,085

(22) PCT Filed: Nov. 4, 2020
(86) PCT No.: PCT/US2020/058797

§ 371 Date: May 3, 2022

Related U.S. Application Data
(60) Provisional application No. 62/930,297, filed on Nov. 4, 2019.

(51) Int. Cl. B01J 21/12; B01J 29/10; B01J 35/10; B01J 35/00; B01J 37/04; B01J 37/06; B01J 37/00; B01J 37/08; C10G 47/18; C10G 45/12

(52) U.S. Cl. CPC B01J 21/12; B01J 29/106; B01J 35/1019; B01J 35/1023; B01J 35/1042; B01J 35/1047; B01J 35/1061; B01J 35/0026; B01J 37/04; B01J 37/06; B01J 37/0009; B01J 37/08; C10G 47/18; C10G 45/12; C10G 2400/04; C10G 2300/1055; C10G 2300/70; C10G 2300/308; C10G 2300/202; C10G 2300/302

(57) ABSTRACT

A silica-alumina based composite material for making hydroprocessing catalysts, is disclosed. The silica-alumina composite material generally comprises at least two silica-aluminas, the first being a modified first silica-alumina, and the second being a second silica-alumina that is unmodified or modified. The first silica-alumina is modified to comprise silica and alumina domains and a silica-alumina interphase. The second silica-alumina may also be modified at the same time or separately to comprise silica and alumina domains and a silica-alumina interphase. The first silica-alumina and the second silica-alumina differ in one or more physical and/or chemical characteristics, e.g., the ratio of silica to alumina, surface area, pore size, pore volume, silica domain size, or alumina domain size. The invention can be used for making catalyst base materials and catalysts useful for upgrading hydrocarbon feedstocks to produce fuels, lubricants, chemicals and other hydrocarbonaceous compositions.

### CROSS-REFERENCE TO RELATED APPLICATIONS

This application claims the benefit of priority to PCT Appl. No. PCT/US20/58797, filed on Nov. 4, 2020, entitled “SILICA-ALUMINA COMPOSITE MATERIALS FOR HYDROPROCESSING APPLICATIONS”, and to U.S. Provisional Appl. Ser. No. 62/930,297, filed on Nov. 4, 2019, the disclosures of which are herein incorporated by reference in their entirety.

### FIELD OF THE INVENTION

The invention concerns silica-alumina based composite materials for making hydroprocessing catalysts. The invention can be used for making catalyst base materials and catalysts useful for upgrading hydrocarbon feedstocks to produce fuels, lubricants, chemicals and other hydrocarbonaceous compositions.

### BACKGROUND OF THE INVENTION

Solid state acidic materials such as crystalline zeolites and amorphous silica-alumina play important roles in hydroprocessing applications. Amorphous silica-alumina is widely used as an important acidic component for the dispersion of base metals (such as, e.g., nickel, cobalt, tungsten, and molybdenum) and noble metals (e.g., palladium and platinum) in bifunctional hydroprocessing catalysts. The pore structure and acidity of silica alumina greatly influence the selectivity of hydroprocessing processes to convert heavier molecules in crude oils to desired products, including, e.g., lubricants, clean fuels and chemicals.

The acidity of silica-alumina generally depends on the dispersion of Al₂O₃ in SiO₂ matrix or, conversely, SiO₂ dispersed in Al₂O₃ matrix. Many synthetic approaches have been reported for controlling the domain size and degree of dispersion of alumina and silica phases within matrix materials, such as coprecipitation, coating, pH swing. Due to the characteristics of amorphous structures, however, it can be difficult to control the pore structure of silica-alumina materials during synthesis processes.

Despite the progress made in preparing hydroprocessing base materials and catalysts from silica-aluminas, a continuing need exists for improved and simplified processes to prepare such materials and catalysts, particularly those leading to improvements in hydroprocessing applications.

### SUMMARY OF THE INVENTION

This invention generally provides a new approach for making amorphous silica-alumina (ASA) composite materials with desirable pore structure characteristics and acidity by combining at least two silica-aluminas that differ in certain properties. The composite material includes a modified silica-alumina that may generally be made in a mixing process with the addition of a modifier. For example, a mulling and/or extrusion process may be used to mix a modifier such as nitric acid with one or more silica-aluminas. Under such shear conditions, the nitric acid or other strong inorganic acid modifier and the shear applied by a mulling/extrusion process is believed to modify surfaces of alumina and silica domains present in the silica-alumina resulting in the formation of silica-alumina interphases such that the composite material is provided with a desirable meso pore structure.

The present invention is broadly directed to a method for making silica-alumina composite materials, particularly such materials for use in making hydroprocessing catalysts. One of the goals of the invention is to provide improvements in catalyst performance that generally also provide lower capital and operating costs for hydroprocessing applications. It is also desirable to provide commercial flexibility in using alternative source silica-alumina materials to prepare suitable composite materials for use as base materials for hydroprocessing catalysts.

In one aspect, the invention concerns a silica-alumina composite material that is suitable for use in making a hydroprocessing catalyst base, the material comprising at least two silica-aluminas, the first being a modified first silica-alumina, and the second being a second silica-alumina that is unmodified or modified. The first silica-alumina is modified to comprise silica and alumina domains and a silica-alumina interphase. The second silica-alumina may also be modified at the same time or separately to comprise silica and alumina domains and a silica-alumina interphase. The first silica-alumina and the second silica-alumina differ in one or more physical and/or chemical characteristics, e.g., the ratio of silica to alumina, surface area, pore size, pore volume, silica domain size, or alumina domain size.

The invention also concerns the use of the composite material to make a hydroprocessing catalyst comprising the composite material, a noble metal, a base metal, and, optionally, a promoter, as well as a method of making the composite material, a method of making the hydroprocessing catalyst, and a method of using the hydroprocessing catalyst in hydroprocessing applications. In one aspect, the silica-alumina composite material may be made by a method comprising combining a first silica-alumina and a second silica-alumina, optionally with a molecular sieve and/or an alumina support, to form a base composition, adding a dilute strong acid aqueous solution to the base composition to form an extrudable composition, and extruding, drying, and calcining the extrudable composition to form the silica-alumina composite material. As noted for the composite material, the first silica-alumina and the second silica-alumina used in the method differ in one or more characteristics selected from the ratio of silica to alumina, surface area, pore size, pore volume, silica domain size, or alumina domain size. A hydroprocessing catalyst according to the invention may be formed from the composite material by impregnating, depositing thereupon, or otherwise combining a catalytically active metal with the composite material.

### BRIEF DESCRIPTION OF THE DRAWINGS

The scope of the invention is not limited by any representative figures accompanying this disclosure and is to be understood to be defined by the claims of the application.

FIG. 1 provides a comparison of pore size distributions (N₂ PSD) for hydroprocessing catalyst base samples as described in the examples.

FIG. 2 provides a comparison of pore size distributions (Hg PSD) for hydroprocessing catalyst base samples as described in the examples.

FIG. 3 shows the silica domains in silica-alumina sample-1 (ASA-1), as used in hydroprocessing catalyst base material HCB-4, as described in the examples.

FIG. 4 provides a comparison of silica domain size distribution for a dual amorphous silica-alumina hydroprocessing catalyst base material with a single amorphous silica-alumina hydroprocessing catalyst base material as described in the examples.

FIG. 5 provides a comparison of the particle size distribution of silica domains in hydroprocessing catalyst base materials HCB-2 and HCB-4 as described in the examples.

FIG. 6 illustrates the catalyst activity for catalysts prepared with different hydroprocessing catalyst base materials as described in the examples.

FIG. 7 illustrates the heavy diesel yield obtained for catalysts prepared with different hydroprocessing catalyst base materials as described in the examples.

FIG. 8 illustrates the total distillate yield obtained for catalysts prepared with different hydroprocessing catalyst base materials as described in the examples.

### DETAILED DESCRIPTION

Although illustrative embodiments of one or more aspects are provided herein, the disclosed processes, and compositions formed therefrom, may be implemented using any number of techniques. The disclosure is not limited to the illustrative or specific embodiments, drawings, and techniques illustrated herein, including any exemplary designs and embodiments illustrated and described herein, and may be modified within the scope of the appended claims along with their full scope of equivalents.

Unless otherwise indicated, the following terms, terminology, and definitions are applicable to this disclosure. If a term is used in this disclosure but is not specifically defined herein, the definition from the IUPAC Compendium of Chemical Terminology, 2nd ed (1997), may be applied, provided that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein is to be understood to apply.

“Periodic Table” refers to the version of IUPAC Periodic Table of the Elements dated Jun. 22, 2007, and the numbering scheme for the Periodic Table Groups is as described in Chemical and Engineering News, 63(5), 27 (1985).

“Hydrocarbonaceous”, “hydrocarbon” and similar terms refer to a compound containing only carbon and hydrogen atoms. Other identifiers may be used to indicate the presence of particular groups, if any, in the hydrocarbon (e.g., halogenated hydrocarbon indicates the presence of one or more halogen atoms replacing an equivalent number of hydrogen atoms in the hydrocarbon).

“Hydroprocessing” or “hydroconversion” refers to a process in which a carbonaceous feedstock is brought into contact with hydrogen and a catalyst, at a higher temperature and pressure, for the purpose of removing undesirable impurities and/or converting the feedstock to a desired product. Such processes include, but not limited to, methanation, water gas shift reactions, hydrogenation, hydrotreating, hydrodesulphurization, hydrodenitrogenation, hydrodemetallation, hydrodearomatization, hydroisomerization, hydrodewaxing and hydrocracking including selective hydrocracking. Depending on the type of hydroprocessing and the reaction conditions, the products of hydroprocessing can show improved physical properties such as improved viscosities, viscosity indices, saturates content, low temperature properties, volatilities and depolarization.

“Hydrocracking” refers to a process in which hydrogenation and dehydrogenation accompanies the cracking/fragmentation of hydrocarbons, e.g., converting heavier hydrocarbons into lighter hydrocarbons, or converting aromatics and/or cycloparaffins (naphthenes) into non-cyclic branched paraffins.

The term “support”, particularly as used in the term “catalyst support”, refers to conventional materials that are typically a solid with a high surface area, to which catalyst materials are affixed. Support materials may be inert or participate in the catalytic reactions, and may be porous or non-porous. Typical catalyst supports include various kinds of carbon, alumina, silica, and silica-alumina, e.g., amorphous silica aluminates, zeolites, alumina-boria, silica-alumina-magnesia, silica-alumina-titania and materials obtained by adding other zeolites and other complex oxides thereto.

“Molecular sieve” refers to a material having uniform pores of molecular dimensions within a framework structure, such that only certain molecules, depending on the type of molecular sieve, have access to the pore structure of the molecular sieve, while other molecules are excluded, e.g., due to molecular size and/or reactivity. Zeolites, crystalline aluminophosphates and crystalline silicoaluminophosphates are representative examples of molecular sieves.

“Middle distillates” include jet fuel, diesel fuel, and kerosene, typically with cut points as shown below:

| | Typical Cut Points, ° F. (° C.) for |
|---|---|
| Products | North American Market |
| Light Naphtha | C₅-180 (C₅-82) |
| Heavy Naphtha | 180-300 (82-149) |
| Jet | 300-380 (149-−193) |
| Kerosene | 380-530 (193-277) |
| Diesel | 530-700 (277-371) |

SiO₂/Al₂O₃ ratio (SAR) is determined by inductively coupled plasma (ICP) elemental analysis. A SAR of infinity means there is no aluminum in the zeolite, i.e., the mole ratio of silica to alumina is infinity.

“Amorphous silica aluminate (ASA)” refers to a synthetic material having some of the alumina present in tetrahedral coordination as shown by nuclear magnetic resonance imaging. ASA can be used as a catalyst or catalyst support. Amorphous silica alumina contains sites which are termed Brönsted acid (or protic) sites, with an ionizable hydrogen atom, and Lewis acid (aprotic), electron accepting sites and these different types of acidic site can be distinguished by the ways in which particular chemical species attaches (e.g., pyridine).

Surface area: determined by nitrogen adsorption at its boiling temperature. BET surface area is calculated by the 5-point method at P/P₀=0.050, 0.088, 0.125, 0.163, and 0.200. Samples are first pre-treated at 400° C. for 6 hours in the presence of flowing, dry nitrogen.

Pore/micropore volume: determined by nitrogen adsorption at its boiling temperature. Micropore volume is calculated by the t-plot method at P/P₀=0.050, 0.088, 0.125, 0.163, and 0.200. Samples are first pre-treated at 400° C. for 6 hours in the presence of flowing, dry nitrogen.

Pore diameter: determined by nitrogen adsorption at its boiling temperature. Mesopore pore diameter is calculated from nitrogen isotherms by the BJH method described in E. P. Barrett, L. G. Joyner and P. P. Halenda, “The determination of pore volume and area distributions in porous substances. I. Computations from nitrogen isotherms.” J. Am. Chem. Soc. 73, 373-380, 1951. Samples are first pre-treated at 400° C. for 6 hours in the presence of flowing, dry nitrogen.

Total pore volume: determined by nitrogen adsorption at its boiling temperature at P/P0=0.990. Samples are first pre-treated at 400° C. for 6 hours in the presence of flowing, dry nitrogen.

Particle density: obtained by applying the formula D=M/V. M is the weight and V is the volume of the catalyst sample. The volume is determined by measuring volume displacement by submersing the sample into mercury under 28 mm Hg vacuum.

Unit cell size: determined by X-ray powder diffraction.

Particle size distribution of silica domains: samples were mounted in a resin and cross-sections were cut, polished and coated to ensure conductivity. Backscattered electron images and elemental maps of the samples were obtained at 20 kV, 20 nA using a JEOL JXA 8230 electron probe microanalyzer (EPMA). The elemental maps were subjected to image segmentation using ZEISS ZEN Intellesis software. After segmentation, the maximum Feret diameter was determined as a structural parameter and used to generate histograms that represent the particle size distribution of silica domains.

In this disclosure, while compositions and methods or processes are often described in terms of “comprising” various components or steps, the compositions and methods may also “consist essentially of” or “consist of” the various components or steps, unless stated otherwise.

The terms “a,” “an,” and “the” are intended to include plural alternatives, e.g., at least one. For instance, the disclosure of “a transition metal” or “an alkali metal” is meant to encompass one, or mixtures or combinations of more than one, transition metal or alkali metal, unless otherwise specified.

All numerical values within the detailed description and the claims herein are modified by “about” or “approximately” the indicated value, and take into account experimental error and variations that would be expected by a person having ordinary skill in the art.

The present invention provides a silica-alumina composite material that is suitable for use in making a hydroprocessing catalyst base. The silica-alumina composite material comprises a modified first silica-alumina, wherein the first silica-alumina is modified to comprise silica and alumina domains and a silica-alumina interphase, and a second silica-alumina, wherein the first silica-alumina and the second silica-alumina differ in one or more characteristics selected from the ratio of silica to alumina, surface area, pore size, pore volume, silica domain size, or alumina domain size.

The composite material may broadly comprise 1-90 wt. %, or 10-80 wt. %, or 20-70 wt. %, or 30-60 wt. %, or 30-50 wt. % of the first silica-alumina; 1-90 wt. %, or 10-80 wt. %, or 20-70 wt. %, or 25-60 wt. %, or 25-50 wt. % of the second silica-alumina; 0-60 wt. %, or 2-50 wt. %, or 5-40 wt. %, or 5-30 wt. %, or 5-20 wt. %, or 5-15 wt. % molecular sieve; and 0-40 wt. %, or 5-40 wt. %, or 10-30 wt. %, or 15-30 wt. % alumina.

A hydroprocessing catalyst according to the invention comprises the composite material in the range of about 40 to less than 100 wt. %, or 40 99 wt. %, or 50-99 wt. %, or 60-99 wt. %, or 70-99 wt. %; a noble metal in the range of 0.1 to 5 wt. %, or 0.1-4 wt. %, or 0.1-3 wt. % or 0.1-2 wt. %, or 0.1-1 wt. %; a base metal in the range of 0-40 wt. %, or 5-40 wt. %, or 5-30 wt. %, or 10-40 wt. %, or 10-30 wt. %, or 10-20 wt. %, or 20-40 wt. %, or 20-30 wt. %; wherein the total base metal content is optionally in the range of 0-40 wt. %, or 5-40 wt. %, or 5-30 wt. %, or 10-40 wt. %, or 10-30 wt. %, or 10-20 wt. %, or 20-40 wt. % or 20-30 wt. %; and a promoter in the range of 0-30 wt. %, or 0-20 wt. %, or 0-10 wt. %, or 5-30 wt. %, or 5-20 wt. %, or 10 30 wt. %, or 10-20 wt. %. Suitable noble metals include, e.g., Pt and Pd, while suitable base metals include Ni, Mo, Co, and W. Combinations of noble, base, and noble and base metals may also be employed. Suitable promoters are described in U.S. Pat. No. 8,637,419 B2 to Zhan.

The invention further provides a method of making a silica-alumina composite material that is suitable for use as, or in making, a hydroprocessing catalyst base, the method comprising combining a first silica-alumina and a second silica-alumina, optionally with a molecular sieve and/or an alumina support, to form a base composition; wherein the first silica-alumina and the second silica-alumina differ in one or more characteristics selected from the ratio of silica to alumina, surface area, pore size, pore volume, silica domain size, or alumina domain size; adding a dilute strong acid aqueous solution, preferably nitric acid, to the base composition to form an extrudable composition; and extruding, drying, and calcining the extrudable composition to form the silica-alumina composite material.

The composite material, and catalyst(s) made therefrom, may be used in a method for hydroprocessing a hydrocarbonaceous feedstock. In general, such methods comprise contacting a hydroprocessing catalyst with the hydrocarbonaceous feedstock and hydrogen under hydroprocessing conditions, the hydroprocessing catalyst comprising at least one metal deposited on a composite material according to the invention. In such hydrocracking processes, the catalyst may advantageously provide increased catalytic activity and comparable heavy diesel and total distillate yield compared with a hydroprocessing catalyst that differs only in that it comprises one of the first silica-alumina or the second silica-alumina but not both.

The modified first silica-alumina is modified by contacting a first silica-alumina with a strong acid, preferably nitric acid, under extrusion conditions. Typically, extrusion conditions comprise temperatures of less than about 200° F. The first silica-alumina and the second silica-alumina typically comprise amorphous silica-alumina or, more particularly, are each amorphous silica-aluminas. The second silica-alumina may also comprise a modified second silica-alumina comprising silica and alumina domains and a silica-alumina interphase. The modified second silica-alumina may also be modified by contacting a second silica-alumina with a strong acid, preferably nitric acid, under similar extrusion conditions, either separately or at the same time as, and/or together, with the first silica-alumina.

The composite material may further comprise a molecular sieve and/or an alumina support. Suitable sieves include, e.g., Y zeolite, preferably a Y zeolite having a unit cell size of between 24.15 Å and 24.45 Å, and, optionally, further comprising a beta zeolite.

The first silica-alumina and/or the second silica-alumina may generally comprise physical characteristics that include one or more of the following:

an alumina content in units of wt. % in the range of 10-98, or 10-80, or 20-80, or 30-80, or 30-70, or 40-70, or 50-70, or 50-80, or 60-80, or 10-50, or 10-40, or 20-40, or 40-98, or 50-98, or 60-98, or 70-98, or 80-98;

a surface area by nitrogen adsorption in units of m²/g in the range of 300-700, or 300-650, or 300-600, or 320-600, or 320-550, or 320-500, or 350-700, or 350-650, or 350-600, or 350-600, or 350-550, or 350-500, or 400-700, or 400-650, or 400-600, or 400-550, or 450-700, or 450-650, or 450-600, or 450-550;

a pore volume by nitrogen adsorption in units of m²/g in the range of 0.7-2.50, or 0.7-2.2, or 0.7-2.0, or 0.7-1.8, or 0.7-1.6, or 0.7-1.4, or 0.7-1.2, or 0.7-1.0, or 0.7-0.9, or 0.75-2.50, or 0.75-2.2, or 0.75-2.0, or 0.75-1.8, or 0.75-1.6, or 0.75-1.4, or 0.75-1.2, or 0.75-1.0, or 0.75-0.9, or 0.85-2.50, or 0.85-2.2, or 0.85-2.0, or 0.85-1.8, or 0.85-1.6, or 0.85-1.4, or 0.85-1.2, or 0.85-1.0, or 0.85-0.9, or 0.9-2.50, or 0.9-2.2, or 0.9-2.0, or 0.9-1.8, or 0.9-1.6, or 0.9-1.4, or 0.9-1.2, or 0.9-1.0, or 1.0-2.50, or 1.0-2.2, or 1.0-2.0, or 1.0-1.8, or 1.0-1.6, or 1.0-1.4, or 1.0-1.2, or 1.0-2.50, or 1.1-2.2, or 1.1-2.0, or 1.1-1.8, or 1.1-1.6, or 1.1-1.4, or 1.1-1.2, or 1.2-2.5, or 1.2-2.0, or 1.2-1.8, or 1.2-1.6, or 1.2-1.4, or 1.3-2.5, or 1.3-2.0, or 1.3-1.8, or 1.3-1.6, or 1.3-1.4, or 1.4-2.5, or 1.4-2.0, or 1.4-1.8, or 1.4-1.6;

a diameter at 50% pore volume D₅₀ in units of nm in the range of 3-35, or 3-20, or 3-15, or 3-10, or 3-8, or 3-7, or 4-25, or 4-20, or 4-15, or 4-10, or 4-8, or 4-7, or 5-25, or 5-20, or 5-15, or 5-10, or 5-8, or 5-7, or 6-25, or 6-25, or 6-20, or 6-15, or 6-10, or 6-8, or 8-25, or 8-20, or 8-15, or 8-10, or 10-25, or 10-20, or 10-15, or 10-13, or 12-25, or 12-20, or 12-15, or 14-25, or 14-20, or 14-18, or 16-25, or 16-20, or 16-18.

The composite material comprising the first and second silica-aluminas may further comprise physical characteristics that include one or more of the following:

a particle density in units of g/mL in the range of 0.6-1.0, or 0.64-1.0, or 0.68-1.0, or 0.72-1.0, or 0.76-1.0, or 0.8-1.0, or 0.84-1.0, or 0.88-1.0, or 0.6-0.96, or 0.64-0.96, or 0.68-0.96, or 0.72-0.96, or 0.76-0.96, or 0.8-0.96, or 0.84-0.96, or 0.88-0.96, or 0.6-0.92, or 0.64-0.92, or 0.68-0.92, or 0.72-0.92, or 0.76-0.92, or 0.8-0.92, or 0.84-0.92, or 0.6-0.88, or 0.64-0.88, or 0.68-0.88, or 0.72-0.88, or 0.76-0.88, or 0.8-0.88, or 0.6-0.84, or 0.64-0.84, or 0.68-0.84, or 0.72-0.84, or 0.76-0.84, or 0.8-0.84, or 0.6-0.8, or 0.64-0.8, or 0.68-0.8, or 0.72-0.8, or 0.76-0.8, or 0.6-0.76, or 0.64-0.76, or 0.68-0.76, or 0.72-0.76;

a surface area by nitrogen adsorption in units of m²/g in the range of 300-700, or 300-650, or 300-600, or 320-600, or 320-550, or 320-500, or 350-700, or 350-650, or 350-600, or 350-600, or 350-550, or 350-500, or 400-700, or 400-650, or 400-600, or 400-550, or 450-700, or 450-650, or 450-600, or 450-550;

a pore volume by nitrogen adsorption in units of m²/g in the range of 0.7-2.50, or 0.7-2.2, or 0.7-2.0, or 0.7-1.8, or 0.7-1.6, or 0.7-1.4, or 0.7-1.2, or 0.7-1.0, or 0.7-0.9, or 0.75-2.50, or 0.75-2.2, or 0.75-2.0, or 0.75-1.8, or 0.75-1.6, or 0.75-1.4, or 0.75-1.2, or 0.75-1.0, or 0.75-0.9, or 0.85-2.50, or 0.85-2.2, or 0.85-2.0, or 0.85-1.8, or 0.85-1.6, or 0.85-1.4, or 0.85-1.2, or 0.85-1.0, or 0.85-0.9, or 0.9-2.50, or 0.9-2.2, or 0.9-2.0, or 0.9-1.8, or 0.9-1.6, or 0.9-1.4, or 0.9-1.2, or 0.9-1.0, or 1.0-2.50, or 1.0-2.2, or 1.0-2.0, or 1.0-1.8, or 1.0-1.6, or 1.0-1.4, or 1.0-1.2, or 1.0-2.50, or 1.1-2.2, or 1.1-2.0, or 1.1-1.8, or 1.1-1.6, or 1.1-1.4, or 1.1-1.2, or 1.2-2.5, or 1.2-2.0, or 1.2-1.8, or 1.2-1.6, or 1.2-1.4, or 1.3-2.5, or 1.3-2.0, or 1.3-1.8, or 1.3-1.6, or 1.3-1.4, or 1.4-2.5, or 1.4-2.0, or 1.4-1.8, or 1.4-1.6;

a diameter at 50% pore volume D₅₀ in units of nm in the range of 3-35, or 3-20, or 3-15, or 3-10, or 3-8, or 3-7, or 4-25, or 4-20, or 4-15, or 4-10, or 4-8, or 4-7, or 5-25, or 5-20, or 5-15, or 5-10, or 5-8, or 5-7, or 6-25, or 6-25, or 6-20, or 6-15, or 6-10, or 6-8, or 8-25, or 8-20, or 8-15, or 8-10, or 10-25, or 10-20, or 10-15, or 10-13, or 12-25, or 12-20, or 12-15, or 14-25, or 14-20, or 14-18, or 16-25, or 16-20, or 16-18.

### EXAMPLES

Representative amorphous silica-aluminas according to the invention were used in the examples are shown in Table 1, each of which is commercially available:

TABLE 1
Amorphous Silica-Aluminas used in the examples

| Silica | | | | | |
|---|---|---|---|---|---|
| alumina | Sample-1 | Sample-2 | Sample-3 | Sample-4 | Sample-5 |
| material | ASA-1 | ASA-2 | ASA-3 | ASA-4 | ASA-5 |
| Chemical | 20-40 | 50-70 | 50-70 | 60-80 | 85-98 |
| Composition | | | | | |
| Al₂O₃, wt % | | | | | |
| Surface Area | 450-600 | 450-600 | 400-550 | 330-550 | 350-550 |
| by N₂ | | | | | |
| Adsorption, | | | | | |
| m²/g | | | | | |
| Pore Volume | 0.78-0.89 | 0.91-1.20 | 1.35-2.00 | 1.05-1.68 | 0.98-1.63 |
| by N₂ | | | | | |
| Adsorption, | | | | | |
| mL/g | | | | | |
| Diameter at | 4.3-63 | 6.8-8.8 | 10.2-12.2 | 15.8-19.8 | 11.0-13.0 |
| 50% Pore | | | | | |
| Volume | | | | | |
| (D₅₀), nm | | | | | |

Hydroprocessing catalyst bases HCB-1 to HCB-7 were prepared according to the invention using the amounts of amorphous silica-aluminas and nitric acid shown in Table 2. The synthesis and characterization of each HCB sample is described below.

TABLE 2
Formulation of hydroprocessing catalyst bases, HCB-1 to HCB-7

| Hydroprocessing | | | | | | Nitric acid |
|---|---|---|---|---|---|---|
| catalyst base | Sample-1 | Sample-2 | Sample-3 | Sample-4 | Sample-5 | (dry oxide |
| (HCB) | ASA-1 | ASA-2 | ASA-3 | ASA-4 | ASA-5 | Base) |
| HCB-1 | 37 wt. % | | | | 30 wt. % | 2 wt. % |
| HCB-2 | 37 wt. % | | | | 30 wt. % | 3 wt. % |
| HCB-3 | | | 34 wt. % | 33 wt. % | | 2 wt. % |
| HCB-4 | 67 wt. % | | | | | 2 wt. % |
| HCB-5 | | | | | 67 wt. % | 2 wt. % |
| HCB-6 | | | | 67 wt. % | | 2 wt. % |
| HCB-7 | | 67 wt. % | | | | 2 wt. % |

*25 wt. % pseudo boehmite alumina powder, balanced by 8 wt. % USY zeolites (SAR = 50-150)

### Synthesis and Characterization of Hydroprocessing Catalyst Base-1 (HCB-1)

Hydroprocessing catalyst base-1 was prepared as follows: 37 parts by weight silica-alumina sample-1, 30 parts by weight silica-alumina sample-5, 25 parts by weight pseudo boehmite alumina powder, and 8 parts by weight of zeolite Y were mixed well. A diluted nitric acid aqueous solution (2 wt. % on dry oxide base) was added to the mix powder to form an extrudable paste. The paste was extruded in 1/16″ asymmetric quadrilobe shape, and dried at 250° F. (121° C.) overnight. The dried extrudates were calcined at 1100° F. (593° C.) for 1 hour with purging excess dry air, and cooled down to room temperature.

### Synthesis and Characterization of Hydroprocessing Catalyst Base-2 (HCB-2)

Hydroprocessing catalyst base-2 was prepared as follows: 37 parts by weight silica-alumina sample-1, 30 parts by weight silica-alumina sample-5, 25 parts by weight pseudo boehmite alumina powder, and 8 parts by weight of zeolite Y were mixed well. A diluted nitric acid aqueous solution (3 wt. % on dry oxide base) was added to the mix powder to form an extrudable paste. The paste was extruded in 1/16″ asymmetric quadrilobe shape, and dried at 250° F. (121° C.) overnight. The dried extrudates were calcined at 1100° F. (593° C.) for 1 hour with purging excess dry air, and cooled down to room temperature.

### Synthesis and Characterization of Hydroprocessing Catalyst Base-3 (HCB-3)

Hydroprocessing catalyst base-3 was prepared as follows: 34 parts by weight silica-alumina sample-3, 33 parts by weight silica-alumina sample-4, 25 parts by weight pseudo boehmite alumina powder, and 8 parts by weight of zeolite Y were mixed well. A diluted nitric acid aqueous solution (2 wt. % on dry oxide base) was added to the mix powder to form an extrudable paste. The paste was extruded in 1/16″ asymmetric quadrilobe shape, and dried at 250° F. (121° C.) overnight. The dried extrudates were calcined at 1100° F. (593° C.) for 1 hour with purging excess dry air, and cooled down to room temperature.

### Synthesis and Characterization of Hydroprocessing Catalyst Base-4 (HCB-4)

Hydroprocessing catalyst base-4 was prepared as follows: 67 parts by weight silica-alumina sample-1, 25 parts by weight pseudo boehmite alumina powder, and 8 parts by weight of zeolite Y were mixed well. A diluted nitric acid aqueous solution (2 wt. % on dry oxide base) was added to the mix powder to form an extrudable paste. The paste was extruded in 1/16″ asymmetric quadrilobe shape, and dried at 250° F. (121° C.) overnight. The dried extrudates were calcined at 1100° F. (593° C.) for 1 hour with purging excess dry air, and cooled down to room temperature.

### Synthesis and Characterization of Hydroprocessing Catalyst Base-5 (HCB-5)

Hydroprocessing catalyst base-5 was prepared as follows: 67 parts by weight silica-alumina sample-5, 25 parts by weight pseudo boehmite alumina powder, and 8 parts by weight of zeolite Y were mixed well. A diluted nitric acid aqueous solution (2 wt. % on dry oxide base) was added to the mix powder to form an extrudable paste. The paste was extruded in 1/16″ asymmetric quadrilobe shape, and dried at 250° F. (121° C.) overnight. The dried extrudates were calcined at 1100° F. (593° C.) for 1 hour with purging excess dry air, and cooled down to room temperature.

### Synthesis and Characterization of Hydroprocessing Catalyst Base-6 (HCB-6)

Hydroprocessing catalyst base-6 was prepared as follows: 67 parts by weight silica-alumina sample-4, 25 parts by weight pseudo boehmite alumina powder, and 8 parts by weight of zeolite Y were mixed well. A diluted nitric acid aqueous solution (2 wt. % on dry oxide base) was added to the mix powder to form an extrudable paste. The paste was extruded in 1/16″ asymmetric quadrilobe shape, and dried at 250° F. (121° C.) overnight. The dried extrudates were calcined at 1100° F. (593° C.) for 1 hour with purging excess dry air, and cooled down to room temperature.

### Synthesis and Characterization of Hydroprocessing Catalyst Base-7 (HCB-7)

Hydroprocessing catalyst base-7 was prepared as follows: 67 parts by weight silica-alumina sample-2, 25 parts by weight pseudo boehmite alumina powder, and 8 parts by weight of zeolite Y were mixed well. A diluted nitric acid aqueous solution (2 wt. % on dry oxide base) was added to the mix powder to form an extrudable paste. The paste was extruded in 1/16″ asymmetric quadrilobe shape, and dried at 250° F. (121° C.) overnight. The dried extrudates were calcined at 1100° F. (593° C.) for 1 hour with purging excess dry air, and cooled down to room temperature.

Table 3 summarizes the physical properties of hydroprocessing catalyst bases HCB-1 to HCB-7.

TABLE 3
Physical properties of hydroprocessing catalyst bases, HCB-1 to HCB-7

| Catalyst Base ID | HCB-1 | HCB-2 | HCB-3 | HCB-4 | HCB-5 | HCB-6 | HCB-7 |
|---|---|---|---|---|---|---|---|
| Particle Density, | 0.82-0.92 | 0.82-0.92 | 0.69-0.79 | 0.80-0.90 | 0.77-0.87 | 0.66-0.76 | 0.84-0.94 |
| g/mL | | | | | | | |
| Surface Area by N₂ | 399-459 | 390-450 | 350-410 | 427-487 | 324-384 | 350-410 | 392-452 |
| Adsorption, m²/g | | | | | | | |
| Pore Volume by N₂ | 0.68-0.88 | 0.65-0.85 | 0.82-1.03 | 0.61-0.81 | 0.76-0.96 | 0.82-1.02 | 0.64-0.84 |
| Adsorption, mL/g | | | | | | | |
| Diameter at 50% | | | | | | | |
| Pore Volume (D₅₀), | 6.0-8.0 | 5.9-7.9 | 8.6-10.6 | 6.4-8.4 | 8.0-1.00 | 9.2-11.2 | 6.3-8.3 |
| nm | | | | | | | |

In certain embodiments within the broader scope of the disclosure, and according to the examples provided herein, suitable hydroprocessing catalysts may be prepared according to the compositional ranges of Table 4.

TABLE 4
Composition of hydroprocessing catalysts

| | |
|---|---|
| Hydroprocessing catalyst base, HCB-x (x = 1-7) | 50-99 wt. % |
| Total noble metal content* | 0.1-3.0 wt. % |
| Total base metal content* | 10-30 wt. % |
| Promotors in U.S. Pat. No. 8,637,419 B2 to Zhan | 0-20 wt. % |

*The metal is selected from Pd, Pt, Ni. Mo, Co, W or a combination thereof

### Results & Discussion

### Pore Size Distribution

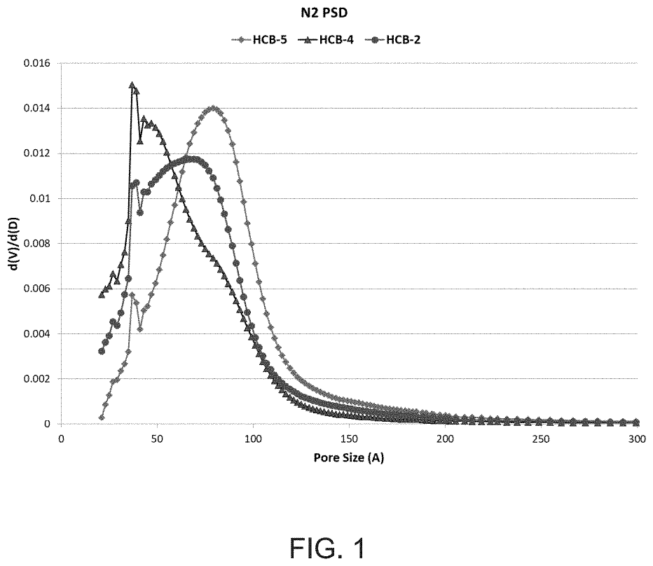

The effect of using two silica-aluminas on the nitrogen pore size distribution (N₂ PSD) was investigated by comparing the PSD's for single amorphous silica-alumina (ASA) hydroprocessing catalyst base samples HCB-4 and HCB-5 with a hydroprocessing catalyst base comprising two amorphous silica-aluminas, sample HCB-2. FIG. 1 shows the nitrogen PSD's for these HCB samples. Single ASA HCB-4 shows a smaller pore size as compared with single ASA HCB-5, which shows a larger pore size. Dual ASA sample HCB-2, synthesized with ASA-1 and ASA-5, displayed a much broader PSD covering nearly all the range provided by the individual amorphous silica-aluminas ASA-1 and ASA-5.

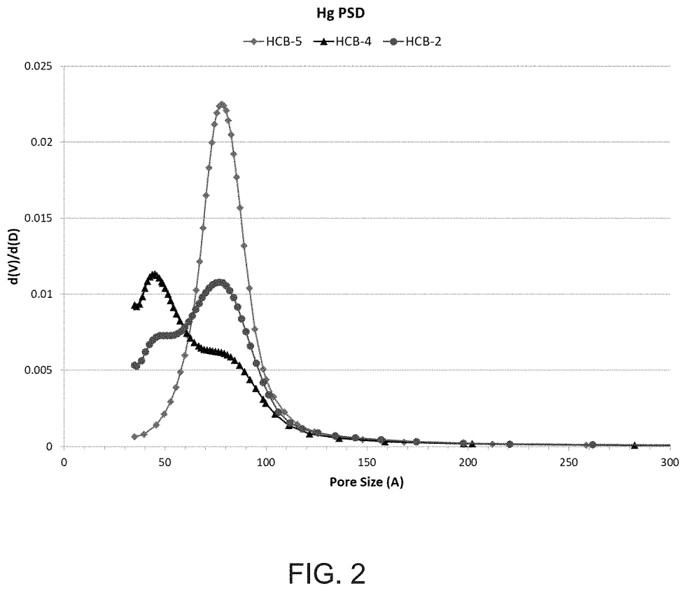

FIG. 2 illustrates the broader pore size distribution obtained due to the use of two ASA's by mercury pore size determination (Hg PSD). A bimodal PSD is shown for hydroprocessing catalyst base HCB-2, in which the two peak positions of the bimodal distribution correspond to those obtained for single ASA samples HCB-4 and HCB-5.

### Elemental Mapping of Silicon

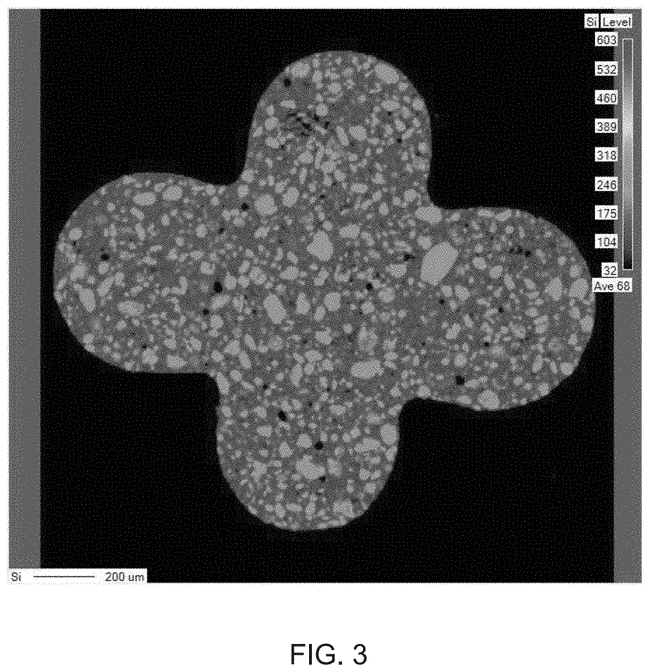

Elemental mapping of silicon was performed in an electron probe microanalyzer (EPMA). The elemental maps allow visual identification (within the resolution limit of the instrument) of silica and alumina domains that can then be measured to yield particle size distributions based on characteristic dimensions, e.g., particle diameter. FIG. 3 shows the silica domains in silica-alumina sample-1 (ASA-1), as used in HCB-4, are in the range measurable by the backscattered electron image that is obtained from EPMA analysis. By comparison, the sizes of silica and alumina domains in sample-5 (ASA-5) are too small to be measured by the backscattered electron image.

### Particle Size and Interphase Formation

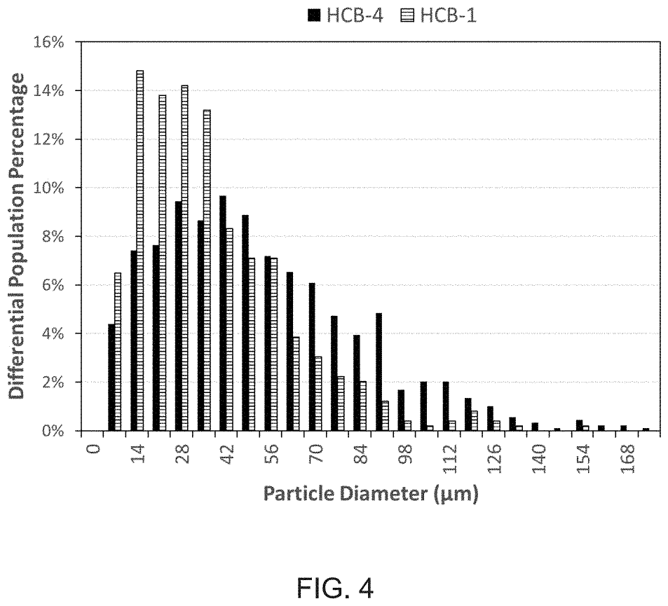

The particle size of silica domains was investigated in order to determine the effects of using two amorphous silica-aluminas in hydroprocessing catalyst base materials, and of modifying one or both ASA's with a strong acid such as nitric acid, as compared with single ASA hydroprocessing catalyst base material. FIG. 4 shows that the particle size of the silica domains in HCB-1 became smaller with a narrower particle size distribution compared to HCB-4 synthesized with only one silica-alumina ASA material (ASA-1). The use of two ASA's, in this case ASA-1 and ASA-5, resulted in a silica-alumina composite material with a broader pore size distribution as shown in FIGS. 1 and 2, but with smaller particles.

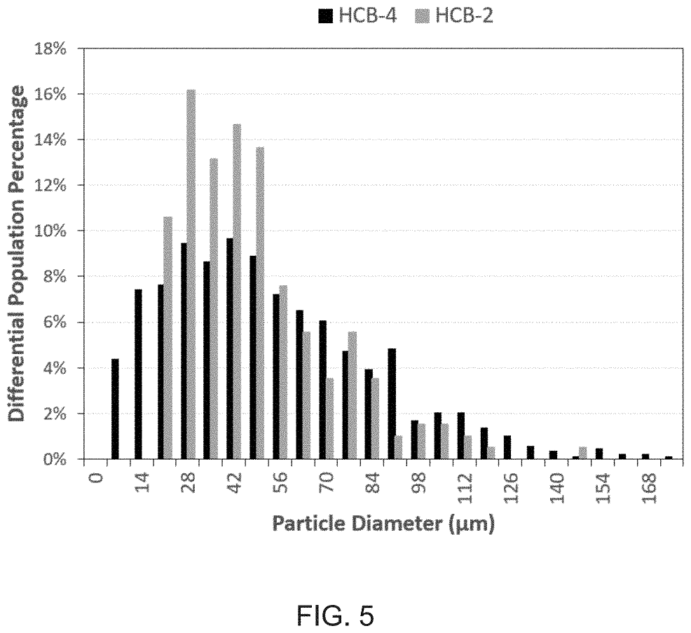

The use of higher concentrations of nitric acid was also investigated and shown to further promote interphase formation of alumina and silica domains, leading to further reduction of the particle size. FIG. 5 shows, for example, that smaller particles with a size less than approximately 14 micrometers observed in HCB-4 or HCB-1 in FIG. 4 completely disappeared in HCB-2 when nitric acid was increased to 3 wt % (dry oxide base).

### Hydrocracking Catalyst Performance

The hydrocracking performance of catalysts comprising the base composite materials of the disclosure was investigated using a typical hydrocracker feedstock. Physical properties of the petroleum feedstock used to evaluate the hydrocracking catalyst performance for catalysts prepared using the hydroprocessing catalyst base materials of the disclosure are provided in Table 6. In each test, the catalyst was contacted with the feedstock under the following process conditions: 2300 PSIG total pressure (2100 PSIA H₂ partial pressure at the reactor inlet), 5000 SCFB H₂ to oil ratio, 1.0 h⁻¹ LHSV.

TABLE 6
Properties of the catalyst performance testing feed

| | |
|---|---|
| API Gravity | 31.0 |
| Sulfur, ppm wt. | 5.78 |
| Nitrogen, ppm wt. | 1.28 |
| PCI | 150 |
| Analysis of hydrocarbon type | |
| Paraffins, LV % | 22.4 |
| Naphthenes, LV % | 64.5 |
| Aromatics, LV % | 13.1 |
| Sulfur, LV % | 0 |
| Viscosity Index, VI | 118 |
| Viscosity @ 100, cSt | 5.816 |
| Viscosity @ 70, cSt | 11.90 |
| Simdis, wt % - ° F.(° C.) | |
| 0.5/5 | 525/638 (274/337) |
| 10/30 | 685/767 (363/408) |
| 50 | 822 (439) |
| 70/90 | 884/973 (473/527) |
| 95/99.5 | 1008/1080 (542/582) |

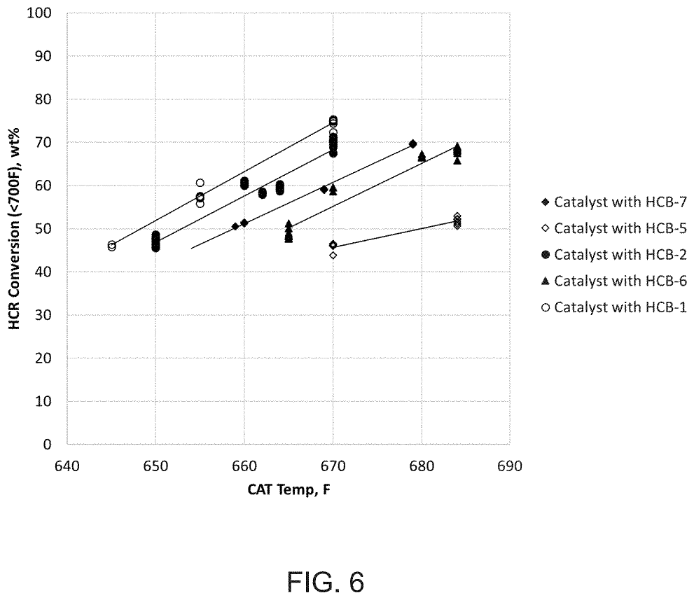

FIG. 6 illustrates the catalyst activity for catalysts contacted with this feedstock that were prepared with different hydroprocessing catalyst base materials according to the disclosure. Those catalysts based on dual ASA catalyst base composite materials, in particular, HCB-1 and HCB-2, were observed to possess increased catalytic activity, as demonstrated by increased hydrocracking (HCR) conversion of the feedstock of Table 6 at the same temperature, when compared with single ASA catalyst HCB materials, HCB-5, HCB-6, and HCB-7.

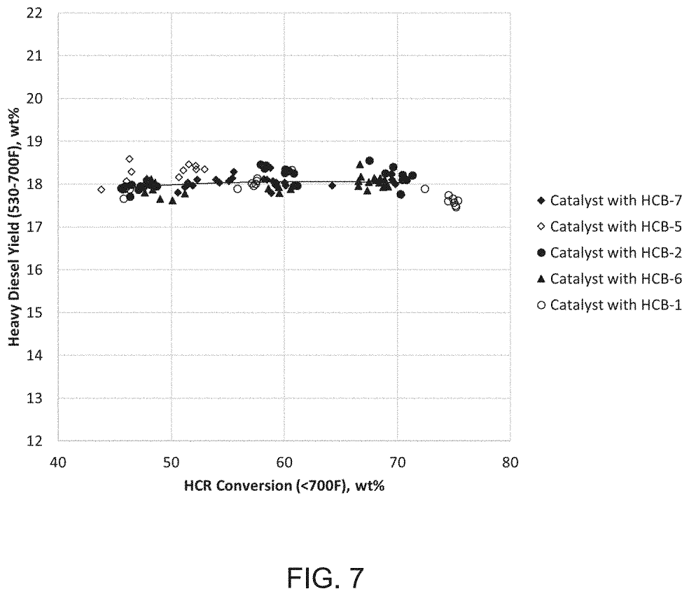

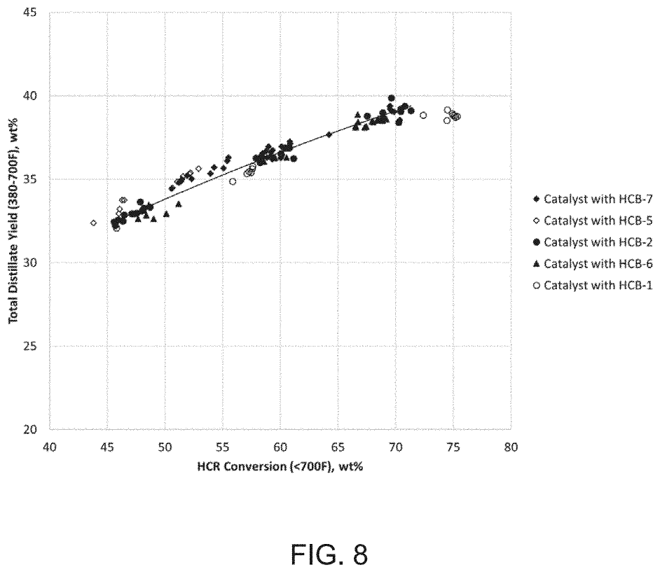

FIG. 7 illustrates the heavy diesel yield obtained for catalysts contacted with this feedstock that were prepared with different hydroprocessing catalyst base materials. FIG. 8 illustrates the total distillate yield obtained for catalysts contacted with this feedstock that were prepared with different hydroprocessing catalyst base materials. Those catalysts based on dual ASA catalyst base composite materials, in particular, HCB-1 and HCB-2, were observed to possess comparable HCR selectivity, as demonstrated by heavy diesel and total distillate yields obtained from hydrocracking of the feedstock of Table 6, when compared with single ASA catalyst HCB materials, HCB-5, HCB-6, and HCB-7.

Additional details concerning the scope of the invention and disclosure may be determined from the appended claims.

The foregoing description of one or more embodiments of the invention is primarily for illustrative purposes, it being recognized that variations might be used which would still incorporate the essence of the invention. Reference should be made to the following claims in determining the scope of the invention.

For the purposes of U.S. patent practice, and in other patent offices where permitted, all patents and publications cited in the foregoing description of the invention are incorporated herein by reference to the extent that any information contained therein is consistent with and/or supplements the foregoing disclosure.

1-20. (canceled)

21. A silica-alumina composite material that is suitable for use in making a hydroprocessing catalyst base, the composite material comprising a modified first silica-alumina, wherein the first silica-alumina is modified to comprise silica and alumina domains and a silica-alumina interphase; and a second silica-alumina; wherein the first silica-alumina and the second silica-alumina differ in one or more characteristics selected from the ratio of silica to alumina, surface area, pore size, pore volume, silica domain size, or alumina domain size.

22. The material of claim 21, wherein the modified first silica-alumina is modified by contacting a first silica-alumina with an acid under extrusion conditions.

23. The material of claim 21, wherein the first silica-alumina and the second silica-alumina comprise amorphous silica-alumina or are both amorphous silica-alumina.

24. The material of claim 21, wherein the second silica-alumina is a modified second silica-alumina comprising silica and alumina domains and a silica-alumina interphase.

25. The material of claim 24, wherein the modified second silica-alumina is modified by contacting a second silica-alumina with an acid under extrusion conditions.

26. The material of claim 21, wherein the material further comprises a molecular sieve and/or an alumina support.

27. The material of claim 26, wherein the molecular sieve comprises a Y zeolite, and, optionally, further comprises a beta zeolite.

28. The material of claim 21, wherein the material comprises
1-90 wt. % of the first silica-alumina;
1-90 wt. % of the second silica-alumina;
0-60 wt. % molecular sieve; and
0-40 wt. % alumina.

29. The material of claim 21, wherein the first silica-alumina and/or the second silica-alumina comprise one or more of the following:
an alumina content in the range of 10-98 wt. %;
a surface area by nitrogen adsorption in the range of 300-700 m²/g;
a pore volume by nitrogen adsorption in the range of 0.7-2.50 m²/g; and
a diameter at 50% pore volume D₅₀ in the range of 3-35 nm.

30. The material of claim 21, wherein the material comprises one or more of the following:
a particle density in the range of 0.6-0.1.0 g/mL;
a surface area by nitrogen adsorption in the range of 300-700 m²/g;
a pore volume by nitrogen adsorption in the range of 0.7-2.50 m²/g; and
a diameter at 50% pore volume D₅₀ in the range of 3-35 nm.

31. A hydroprocessing catalyst comprising
the material of claim 21 in the range of about 40 to less than 100 wt. %;
a noble metal in the range of 0.1 to 5 wt. %;
a base metal in the range of 0-40 wt. %; wherein the total base metal content is optionally in the range of 0-40 wt. %; and
a promoter in the range of 0-30 wt. %.

32. A method of making a silica-alumina composite material that is suitable for use as, or in making, a hydroprocessing catalyst base, the method comprising
combining a first silica-alumina and a second silica-alumina, optionally with a molecular sieve and/or an alumina support, to form a base composition;
wherein the first silica-alumina and the second silica-alumina differ in one or more characteristics selected from the ratio of silica to alumina, surface area, pore size, pore volume, silica domain size, or alumina domain size;
adding an acidic aqueous solution to the base composition to form an extrudable composition; and
extruding, drying, and calcining the extrudable composition to form the silica-alumina composite material.

33. The method of claim 32, wherein the first silica-alumina and the second silica-alumina comprise amorphous silica-alumina or are amorphous silica-alumina.

34. The method of claim 32, wherein the base composition comprises the first silica-alumina, the second silica-alumina, a Y zeolite, and an alumina, optionally, further comprising a beta zeolite.

35. The method of claim 32, wherein the base composition comprises
1-90 wt. % of the first silica-alumina;
1-90 wt. % of the second silica-alumina;
0-60 wt. % molecular sieve; and
0-40 wt. % alumina.

36. The method of claim 32, wherein the first silica-alumina and/or the second silica-alumina comprise one or more of the following:
an alumina content in the range of 10-98 wt. %;
a surface area by nitrogen adsorption in the range of 300-700 m²/g;
a pore volume by nitrogen adsorption in the range of 0.7-2.50 m²/g; and
a diameter at 50% pore volume D₅₀ in the range of 3-35 nm.

37. The method of claim 32, wherein the silica-alumina composite material comprises one or more of the following:
a particle density in the range of 0.6-0.1.0 g/mL;
a surface area by nitrogen adsorption in the range of 300-700 m²/g;
a pore volume by nitrogen adsorption in the range of 0.7-2.50 m²/g; and
a diameter at 50% pore volume D₅₀ in the range of 3-35 nm.

38. A silica-alumina composite material made by the method of claim 32.

39. A method for hydroprocessing a hydrocarbonaceous feedstock, comprising contacting a hydroprocessing catalyst with the hydrocarbonaceous feedstock and hydrogen under hydroprocessing conditions, wherein the hydroprocessing catalyst is the catalyst of claim 31.

40. The method of claim 39, wherein the method comprises a hydrocracking process operated under hydrocracking conditions in which the catalyst provides increased catalytic activity and comparable heavy diesel and total distillate yield compared with a hydroprocessing catalyst that differs only in that it comprises one of the first silica-alumina or the second silica-alumina but not both.
